(19) United States
(12) Patent Application Publication
(10) Pub. No.: US 2021/0221334 A1
(43) Pub. Date: Jul. 22, 2021

(54) WINDSCREEN WIPER DEVICE

(71) Applicant: TRICO BELGIUM SA, Aubange (BE)

(72) Inventor: Thomas Friscioni, Mexy (FR)

(21) Appl. No.: 17/256,257

(22) PCT Filed: Jun. 25, 2018
(86) PCT No.: PCT/EP2018/066900

§ 371 Date: Dec. 28, 2020

(51) Int. Cl. B60S 1/52; B60S 1/38

(52) U.S. Cl. CPC B60S 1/522; B60S 1/3848

(57) ABSTRACT

A windscreen wiper device comprising an elongated wiper blade of the flat blade type made of a flexible material, adapted to be placed in abutment with a windscreen to be wiped, where the wiper blade includes at least one groove in which a longitudinal elastic strip is disposed. The windscreen wiper device includes an oscillating arm connected to the wiper blade. The oscillating arm is able to move between a downward reversal position in use facing towards a bottom edge of the windscreen to be wiped and an upward reversal position in use facing away from the bottom edge of the windscreen to be wiped. The windscreen wiper device also comprises a washing unit having at least one nozzle for spraying a washing liquid onto the windscreen to be wiped. The washing unit is arranged for automatically disposing a washing liquid onto the windscreen to be wiped in a direction of movement of the oscillating arm and ahead of the wiper blade.

### BACKGROUND OF THE INVENTION

A windscreen wiper device with a wiper blade of the “flat blade type” is generally known. In such a wiper blade of the “flat blade type,” no use is made of several yokes pivotally connected to each other. Instead, the wiper blade is biased by the longitudinal elastic strip (functioning as an elastic carrier element), as a result of which it exhibits a specific curvature. Usually, washing liquid is sprayed from a nozzle near a bonnet of a vehicle onto the wiped windscreen. A source for the washing liquid, such as a water source or reservoir, a pump, and an electricity source, such as a battery, are preferably located under a bonnet of the car. A disadvantage of a nozzle fixedly mounted on (or below) a bonnet of a car for spraying a washing liquid onto the car's windscreen to be wiped is the following. In practice it has become apparent that the windscreen cannot effectively be cleaned, as the nozzle emits the washing fluid at a large distance relative to the windscreen, so that a relatively large amount of the washing fluid does not effectively reach a wiping pattern on the windscreen to be wiped. Further, it has become apparent that in the prior art, a large amount of liquid (consumption) is required in an attempt to clean the windscreen to be wiped. Further, if the washing fluid is spread onto the car's body instead of onto the windscreen to be wiped, it may damage the car. Indeed, ethanol, methanol and other components of the washing fluid are believed to have a corrosive effect on paint, rubber, car wax and plastics, for example.

### SUMMARY OF THE INVENTION

The present invention relates to a windscreen wiper device, particularly for automobiles, comprising an elongated wiper blade of the flat blade type made of a flexible material, which can be placed in abutment with a windscreen to be wiped. The wiper blade includes at least one groove in which a longitudinal elastic strip is disposed. The wiper blade comprises a connecting device for an oscillating arm. The oscillating arm can be pivotally connected to the connecting device about a pivot axis near a free end thereof. The oscillating arm is able to move between a downward reversal position in use facing towards a bottom edge of the windscreen to be wiped and an upward reversal position in use facing away from the bottom edge of the windscreen to be wiped. The windscreen wiper device comprises a washing unit to be activated having at least one nozzle for spraying a washing liquid onto the windscreen to be wiped. Preferably, the oscillating arm can be pivotally connected to the connecting device with the interposition of a joint part.

In the framework of the present invention the following is noted. The connecting device, also called “connector,” is preferably made of plastic. The connector is preferably made in one piece, also called a “one piece connector.” Also the joint part, also called a “spacer,” is preferably made of plastic. The joint part acts as a spacer interposed between the connecting device and the oscillating arm. The wiper blade is preferably made of an elastomer material, such as rubber, and is particularly made through extrusion. Particularly, the wiper blade comprises a spoiler at a side facing away from the windscreen to be wiped. The wiper blade and the spoiler are preferably made in one piece. The longitudinal groove is preferably a central longitudinal groove accommodating the longitudinal strip. The longitudinal strip is also called a “flexor.” The connecting device is preferably fixedly connected to the longitudinal strip(s) particularly through a welding, brazing (“soldering”), gluing or clamping operation or with the help of a pin inserted through the connecting device and the longitudinal strip(s). In the alternative or in addition thereto, the connecting device is clamped onto the flexible material of the wiper blade, particularly in case the latter is equipped with a central longitudinal groove for the carrier element. Preferably, the connecting device and the joint part are provided with mutually cooperating pivot means for pivotally connecting the joint part to the connecting device. All the above preferred features of the present invention can be used alone or in combination with any other feature(s), as a skilled person would appreciate.

An object of the invention is to provide, at minimum costs—without using complex machinery and additional tools—a simple windscreen wiper device to effectively clean a windscreen to be wiped, where less washing liquid is required to clean the windscreen to be wiped. In order to accomplish that objective, the washing unit is arranged for automatically disposing a washing liquid onto the windscreen to be wiped only in a direction of movement of the oscillating arm and ahead of the wiper blade. The washing unit is preferably activated manually, i.e. by hand (of the driver). Hence, the washing unit—upon activation thereof—does not randomly spray the washing fluid onto the windscreen to be wiped, but instead sprays the washing liquid onto the windscreen to be wiped in a predetermined direction, namely always in a direction of movement of the oscillating arm and ahead of the wiper blade. Thus, the washing liquid on the windscreen to be wiped is always directly wiped away by the oscillating arm, either in an upward movement or downward movement thereof. This is preferably realized by a controlled pump in the washing unit upon activation. Hence the following situations would be avoided:
the oscillating arm would move downwardly and the washing liquid would stay behind on the windscreen waiting to be wiped away once the oscillating arm moves upwardly again, and/or
the oscillating arm would move upwardly and the washing liquid would stay behind on the windscreen waiting to be wiped away once the oscillating arm moves downwardly again.

The visibility of the driver is, therefore, never hindered by droplets of washing liquid.

Preferably, the oscillating arm is provided with the nozzle. In the alternative, the wiper blade is provided with the nozzle. By connecting the nozzle directly to the oscillating arm or directly to the wiper blade wiper, the nozzle is not only fixed in a reliable and controllable manner, although detachably in case of repair or replacement of the nozzle, but the nozzle may also be hidden from the outside and thus invisible for a driver and people outside. Further, by connecting the nozzle directly to the oscillating arm or directly to the wiper blade wiper, the nozzle is located at a very small distance relative to the windscreen to be wiped and is allowed to directly follow any oscillatory movement of the windscreen wiper arm, so that less washing fluid exiting the nozzle can be effectively sprayed thereon, with all positive consequences involved as to effective cleaning of the windscreen to be wiped and safe visibility for a driver. Finally, by connecting the nozzle directly to the oscillating arm or directly to the wiper blade wiper, damage of (parts of) the car by the washing liquid is avoided, as the washing liquid does not reach the car's body.

In the alternative, the oscillating arm and the wiper blade may each be provided with a nozzle of the washing unit. In the alternative, the oscillating arm comprises two nozzles. In both of these cases the washing unit includes a first nozzle in combination with a second nozzle for spraying a washing liquid onto the windscreen to be wiped. Hence, the washing liquid is sprayed from at least two locations onto the windscreen to be wiped, namely washing liquid exits from the first nozzle connected to the oscillating arm, and washing liquid exits from the second nozzle connected to the wiper blade or to another location on the oscillating arm. Thus, the windscreen can be cleaned efficiently over a very large wiping area, particularly at high speeds. In that case the first and second nozzles are preferably each connected to a corresponding inlet, i.e. two inlets are provided.

Preferably, one end of the oscillating arm is arranged to be pivotally connected to a mounting head mounted on a drive shaft. Another end of the oscillating arm is arranged to be pivotally connected to the elongated wiper blade to be placed in abutment with a windscreen to be wiped. The mounting head is usually fixed for rotation to the shaft, where the shaft is rotatable alternately in a clockwise and in a counter-clockwise sense carrying the mounting head into rotation. Thus, in turn the mounting head draws the connecting device into rotation and thereby moves the flat blade. In the alternative, the mounting head is fixed for translation to a carriage, where the carriage can be translated alternately in a one linear direction and in another counter linear direction carrying the mounting head into translation. The present invention can therefore be used for circular or linear movement of the mounting head.

It is noted that the present invention is not restricted to cars, but also refers to rail coaches and other (fast) vehicles.

In a preferred embodiment of a windscreen wiper device in accordance with the invention the washing unit is arranged for disposing a washing liquid onto the windscreen to be wiped in a direction away from the bottom edge of the windscreen to be wiped (and ahead of the wiper blade) only upon movement of the oscillating arm towards the upward reversal position. Particularly, the washing unit is arranged for disposing a washing liquid onto the windscreen to be wiped during a time period in which the oscillating arm encloses an angle α between 0° and 70° with the horizontal, particularly between 0° and 60°, and more particularly between 0° and 45°. Tests have shown that, surprisingly and unexpectedly, the windscreen can thus be cleaned in an efficient manner, using less washing liquid.

In another preferred embodiment of a windscreen wiper device according to the invention the washing unit is arranged for disposing a washing liquid onto the windscreen to be wiped in a direction towards the bottom edge of the windscreen to be wiped (and ahead of the wiper blade) only upon movement of the oscillating arm towards the downward reversal position. Particularly, the washing unit is arranged for disposing a washing liquid onto the windscreen to be wiped during a time period in which the oscillating arm encloses an angle α between 90° (i.e. the oscillating arm is in its upward reversal position) and 30° with the horizontal, and particularly between 90° (i.e. the oscillating arm is in its upward reversal position) and 45°. Tests have shown that, surprisingly and unexpectedly, the windscreen can thus be cleaned in an efficient manner, using less washing liquid.

In another preferred embodiment of a windscreen wiper device in accordance with the invention the nozzle comprises a spraying head detachably connected to the nozzle. Preferably, the spraying head is detachably connected to the nozzle through a snapping connection.

In another preferred embodiment of a windscreen wiper device according to the invention one end of the oscillating arm is arranged to be pivotally connected to a mounting head mounted on a drive shaft. Another end of the oscillating arm is arranged to be pivotally connected to the wiper blade. The oscillating arm can oscillate to-and-from between the downward reversal position and the upward reversal position, where the oscillating arm is provided with the nozzle. Particularly, at least a part of the oscillating arm is made integrally from a single sheet material, where parts of the sheet material are folded outwardly to form legs of a U-shaped cross-section of the oscillating arm, and where one of the legs is connected to the nozzle.

In another preferred embodiment of a windscreen wiper device in accordance with the invention the other end of the oscillating arm is arranged to be pivotally connected through a bayonet connection to the wiper blade.

In another preferred embodiment of a windscreen wiper device according to the invention the wiper blade comprises the nozzle. Preferably, the wiper blade comprises a central groove for the longitudinal elastic strip, where the central groove is defined by a bottom wall, a top wall and side walls, and one of the side walls comprises the nozzle.

### BRIEF DESCRIPTION OF THE DRAWINGS

The invention will now be explained in more detail with reference to figures illustrated in a drawing, wherein:

FIG. 1 is a schematic side view of a windscreen wiper arm equipped with a wiper blade of the flat blade type;

FIG. 2 is a schematic bottom view of the windscreen wiper arm of FIG. 1;

FIG. 3 shows diagrammatically how the washing unit (with a control device) is arranged for disposing a washing liquid onto the windscreen to be wiped; and

FIG. 4 shows diagrammatically how the washing unit (with a control device) is arranged for disposing a washing liquid onto the windscreen to be wiped only in a direction of movement of the oscillating arm and ahead of the wiper blade.

### DETAILED DESCRIPTION OF PREFERRED EMBODIMENTS

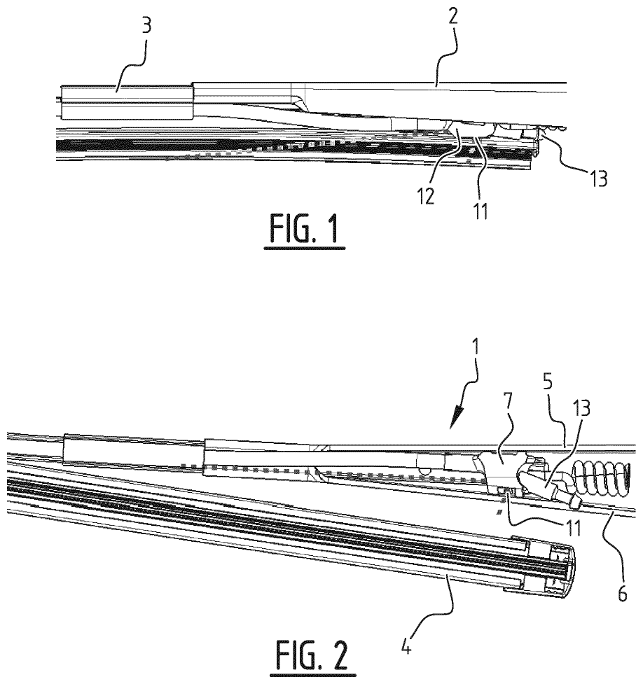

FIGS. 1 and 2 show a windscreen wiper arm 1, particularly for automobiles, that is able to oscillate to-and-from between a first reversal position and a second reversal position over a windscreen to be wiped (not shown). The windscreen wiper arm 1 includes a wiper arm member 2 having a substantially U-shaped cross-section and a wiper rod 3. A first free end of the wiper arm member 2 is arranged to be pivotally connected to a mounting head (not shown) mounted on a drive shaft (not shown). The drive shaft is rotatable by a small motor alternately in a clockwise and in a counter-clockwise sense carrying the mounting head into rotation. Thus, in turn the mounting head draws the windscreen wiper arm 1 into rotation and thereby moves a wiper blade 4 of the flat blade type connected thereto. A second free end of the wiper arm member 2 (opposite the first free end) is rigidly connected to the wiper rod 3. The wiper arm member 2 is made integrally from a single sheet material, for example a metal, where parts of the sheet material are folded outwardly to form legs 5, 6 of a U-shaped cross-section of the wiper arm member 2. The legs 5, 6 of the U-shaped cross-section of the wiper arm member 2 are locally folded around the wiper rod 3 to form a rigid interconnection. As shown, a first free end of the wiper rod 3 extends inside the U-shaped cross-section of the wiper arm member 2. A second free end of the wiper rod 3 (opposite the first free end) is connected to the wiper blade 4 to be placed in abutment with a windscreen to be wiped.

As shown in FIGS. 1 and 2, the windscreen wiper arm 1 is provided with a nozzle 7, which is part of a washing unit for spraying a washing liquid onto the windscreen to be wiped. The nozzle 7 is detachably snapped to the wiper rod 3 inside the U-shaped cross-section of the wiper arm member 2 to allow its repair and/or replacement. As shown, the nozzle 7 includes two spraying openings 11, 12 for spraying the washing fluid onto the windscreen to be wiped. Further, the nozzle 7 includes an inlet pipe 13 for conveying the washing liquid towards the nozzle 7. The nozzle 7 may include a spraying head detachably connected to the nozzle through a snapping connection.

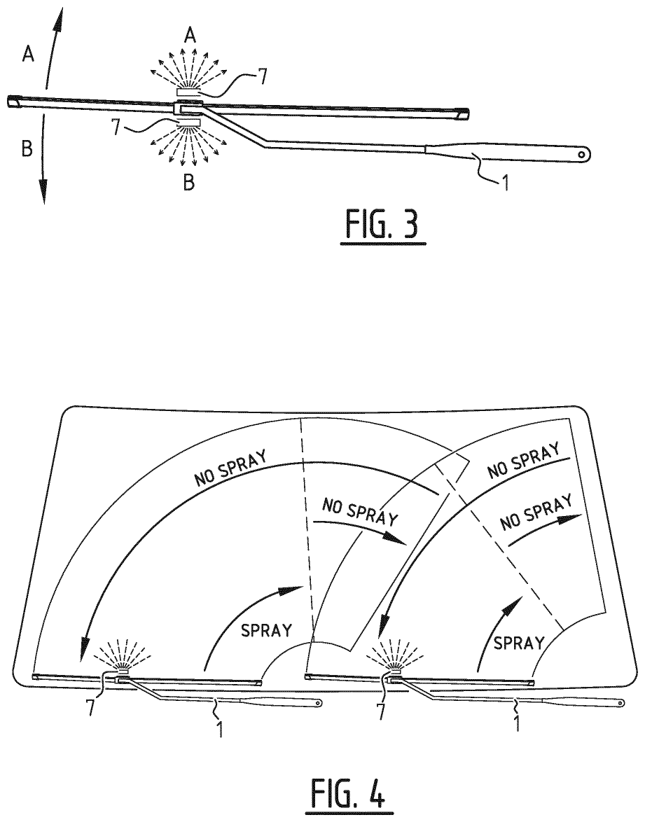

FIG. 3 shows schematically that washing liquid may be sprayed onto the windscreen to be wiped only in a direction of movement of the windscreen wiper arm 1 and ahead of the wiper blade 4. Hence, the nozzle 7 of the washing unit—upon activation thereof by hand, for example—does not randomly spray the washing fluid onto the windscreen to be wiped, but instead sprays the washing liquid onto the windscreen to be wiped in a predetermined direction, namely always in a direction of movement of the oscillating arm 1 and ahead (i.e. in front of) of the wiper blade 4. Thus, the washing liquid on the windscreen to be wiped is always directly wiped away by the windscreen wiper arm 1, either in an upward movement in the direction of arrow A or in a downward movement in the direction of arrow B. For example, if the windscreen wiper arm 1 is moving upwardly in the direction of arrow A, the washing liquid would be sprayed by the nozzle 7 in the direction of arrow A. If the windscreen wiper arm 1 is moving downwardly in the direction of arrow B, the washing liquid would be sprayed by the nozzle 7 in the direction of arrow B.

In addition to what is depicted in FIG. 3, FIG. 4 shows schematically that washing liquid is disposed by the nozzle 7 onto the windscreen to be wiped not only in a direction of arrow A during an upward movement of the windscreen wiper arm 1, but also only during a time period in which the windscreen wiper arm 1 encloses an angle α between 0° and 70° with the horizontal, particularly between 0° and 60°, and more particularly between 0° and 45°. No washing liquid is sprayed during the rest of the upward movement of the windscreen wiper arm 7 (i.e. the rest of its upward stroke), or during the downward movement of the wiper arm 7 (i.e. the full downward stroke). Less washing liquid is thus required, while the windscreen to be wiped can still be cleaned effectively.

Alternatively, washing liquid may also be disposed by the nozzle 7 onto the windscreen to be wiped in a direction of arrow B during a downward movement of the windscreen wiper arm 1. The washing liquid may be disposed only during a time period in which the windscreen wiper arm 1 encloses an angle α between 90° (i.e. the oscillating arm is in its upward reversal position) and 30° with the horizontal, and particularly between 90° (i.e. the oscillating arm is in its upward reversal position) and 45°. No washing liquid is sprayed during the rest of the downward movement of the windscreen wiper arm 7 (i.e. the rest of its downward stroke).

The present invention is not restricted to the embodiment shown in the figures, but extends also to other preferred variants falling within the scope of the appended claims.

1. A windscreen wiper device comprising:
an elongated wiper blade of the flat blade type made of a flexible material, adapted to be placed in abutment with a windscreen to be wiped, wherein said wiper blade includes at least one grooved in which a longitudinal elastic strip is disposed;
an oscillating arm connected to said wiper blade, wherein said oscillating arm is able to move between a downward reversal position in use facing towards a bottom edge of the windscreen to be wiped and an upward reversal position in use facing away from the bottom edge of the windscreen to be wiped; and
a washing unit having at least one nozzle for spraying a washing liquid onto the windscreen to be wiped, wherein said washing unit is arranged for automatically disposing a washing liquid onto the windscreen to be wiped in a direction of movement of said oscillating arm and ahead of said wiper blade.

2. The windscreen wiper device according to claim 1, wherein said washing unit is arranged for disposing the washing liquid onto the windscreen to be wiped in a direction away from the bottom edge of the windscreen to be wiped only upon movement of said oscillating arm towards the upward reversal position.

3. The windscreen wiper device according to claim 2, wherein said washing unit is arranged for disposing the washing liquid onto the windscreen to be wiped during a time period in which said oscillating arm encloses an angle α between 0° and 70° with the horizontal, particularly between 0° and 60°, more in particular between 0° and 45°.

4. The windscreen wiper device according to claim 1, wherein said washing unit is arranged for disposing a washing liquid onto the windscreen to be wiped in a direction towards the bottom edge of the windscreen to be wiped only upon movement of said oscillating arm towards the downward reversal position.

5. The windscreen wiper device according to claim 4, wherein said washing unit is arranged for disposing the washing liquid onto the windscreen to be wiped during a time period in which said oscillating arm encloses an angle α between 90° and 30° with the horizontal, particularly between 90° and 45°.

6. The windscreen wiper device according to claim 1, wherein said nozzle comprises a spraying head detachably connected thereto.

7. The windscreen wiper device according to claim 6, wherein said spraying head is detachably connected to said nozzle through a snapping connection.

8. The windscreen wiper device according to claim 1, wherein one end of said oscillating arm is adapted to be pivotally connected to a mounting head mounted on a drive shaft and wherein another end of said oscillating arm is adapted to be pivotally connected to said wiper blade, wherein said oscillating arm can oscillate to-and-from between the downward reversal position and the upward reversal position, and wherein said washing unit is mounted on said oscillating arm.

9. The windscreen wiper device according to claim 8, wherein at least a part of said oscillating arm comprises a single sheet material, wherein parts of said sheet material are folded outwardly to form legs of a U-shaped cross-section of said oscillating arm, and wherein said washing unit is mounted on one of said legs.

10. The windscreen wiper device according to claim 8, wherein the other end of said oscillating arm adapted to be pivotally connected through a bayonet connection to said wiper blade.

11. The windscreen wiper device according to claim 1, wherein said washing unit is mounted on said wiper blades.

12. The windscreen wiper device according to claim 11, wherein said wiper blade comprises a central groove for said longitudinal elastic strip, wherein said central groove is defined by a bottom wall, a top wall and side walls, and wherein said washing unit is mounted on one of said side walls.
